(19) United States
(12) Patent Application Publication
(10) Pub. No.: US 2005/0137918 A1
(43) Pub. Date: Jun. 23, 2005

(54) Method, system and program product for assessing an enterprise architecture

(75) Inventor: Pirooz M. Joodi, Dublin, OH (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/740,107

(22) Filed: Dec. 17, 2003

(51) Int. Cl. G06F 17/60; G06F 15/177

(52) U.S. Cl. 705/7; 709/221

(57) ABSTRACT

Under the present invention, data corresponding to an enterprise architecture is first gathered. This data includes, among other things: responses to a plurality of questions pertaining to the enterprise architecture; information pertaining to integration challenges of enterprise applications within the architecture; and any risks within the enterprise architecture. Based on the responses and the information, an operational performance of the enterprise architecture is determined and compared to best practice data. The best practice data corresponds to similar enterprise architectures that were determined to have performed at optimal levels. Based on the comparison, an assessment of the enterprise architecture is generated. Architectural alternatives are then recommended based on the assessment and the identified risks.

### FIELD OF THE INVENTION

In general, the present invention relates to a method, system and program product for assessing an enterprise (computer) architecture. Specifically, under the present invention an enterprise architecture is assessed based on a statistical, analytical and cognitive analysis thereof.

### BACKGROUND OF THE INVENTION

As computer technology continues to advance, businesses and other organizations are increasingly implementing more complex enterprise (computer) architectures. For example, in today's market, an automobile manufacturer will typically implement a computer infrastructure to accommodate dealers, customers as well as the underlying manufacturing operation. In many of these cases, the enterprise architecture will change/grow with time to accommodate changes in the business. Unfortunately, as such changes occur, it is often difficult to determine whether the overall enterprise architecture has remained optimal for the business. For example, resources added to improve one aspect of the business might actually have an adverse effect on existing resources that are designed to aid another aspect of the business. Moreover, such changes could expose unforeseen risks within the enterprise architecture.

To this extent, it would be beneficial for an enterprise architecture to periodically undergo an assessment to determine if any changes are needed. Heretofore, attempts have been made to provide techniques for assessing an enterprise architecture. No such attempt, however, provides the extent of assessment that is currently needed. Specifically, the previous assessment techniques focus on the technical aspects of the enterprise architecture. For example, the previous techniques will examine issues such as storage space, computing bandwidth, etc. without considering the underlying business environment in which the enterprise architecture is implemented. Further, no existing technique considers the risks currently being experienced within the enterprise architecture in making the assessment. Knowing the underlying business environment and the current risks could not only impact the determination of whether the enterprise architecture is fully optimized, but also whether certain changes are necessary. Still yet, no existing technique assesses an enterprise architecture by comparing its operational performance to best practice data. That is, no existing technique considers how other similar enterprise architectures perform in assessing an enterprise architecture.

In view of the foregoing, there exists a need for a method, system and program product for assessing an enterprise architecture. Specifically, a need exists whereby an enterprise architecture is assessed on the technical business environment in which it is implemented as well as the integration challenges of applications therein. A further need exists for the assessment of the enterprise architecture to be based on best practice data for other similar enterprise architectures. Still yet, a need exists for architectural alternatives to be recommended based on the assessment and any risks identified within the architecture.

### SUMMARY OF THE INVENTION

In general, the present invention provides a method, system and program product for assessing an enterprise architecture. Specifically, under the present invention, a set of data corresponding to the enterprise architecture is first gathered. Such data includes, among other things: responses to a plurality of questions pertaining to the enterprise architecture; information pertaining to integration challenges of enterprise applications within the enterprise architecture; and any risks within the enterprise architecture. Based on the responses and the integration information, an operational performance of the enterprise architecture is determined and compared to best practice data. The best practice data corresponds to similar enterprise architectures that were determined to have performed at optimal levels. Based on the comparison, an assessment of the enterprise architecture is generated. Architectural alternatives are then recommended based on the assessment and the identified risks.

A first aspect of the present invention provides a method for assessing an enterprise architecture, comprising: receiving responses for a plurality of questions regarding the enterprise architecture; receiving information pertaining to integration challenges of enterprise applications within the enterprise architecture; providing a viability assessment that is populated based on risks within the enterprise architecture; determining an operational performance of the enterprise architecture based on the responses and the information; comparing operational performance to best practice data; and providing an assessment of the enterprise architecture based upon the comparing.

A second aspect of the present invention provides a computerized system for assessing an enterprise architecture, comprising: an input system for receiving responses to a plurality of questions regarding the enterprise architecture, information pertaining to integration challenges of enterprise applications within the enterprise architecture, and risks within the enterprise architecture; a performance determination system for determining an operational performance of the enterprise architecture based on the responses and the information; a comparison system for comparing operational performance to best practice data; and an assessment system for providing an assessment of the enterprise architecture based upon the comparison.

A third aspect of the present invention provides a program product stored on a recordable medium for assessing an enterprise architecture, which when executed, comprises: program code for receiving responses to a plurality of questions regarding the enterprise architecture, information pertaining to integration challenges of enterprise applications within the enterprise architecture, and risks within the enterprise architecture; program code for determining an operational performance of the enterprise architecture based on the responses and the information; program code for comparing operational performance to best practice data; and program code for providing an assessment of the enterprise architecture based upon the comparison.

Therefore, the present invention provides a method, system and program product for assessing an enterprise architecture.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for assessing an enterprise architecture according to the present invention.

FIG. 2 depicts an illustrative enterprise architecture that is assessed according to the present invention.

FIG. 3 depicts an illustrative method flow diagram according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For convenience purposes, the Best Mode for Carrying out the Invention will have the following sections:
I. General Description
II. Computerized Implementation
   A. Data Collection
      1. Responses to Questionnaire
      2. Integration Information
      3. Risks within the Enterprise Architecture
III. Assessment of the Enterprise Architecture
   I. General Description

As indicated above, the present invention provides a method, system and program product for assessing an enterprise architecture. Specifically, under the present invention, a set of data corresponding to the enterprise architecture is first gathered. Such data includes, among other things: responses to a plurality of questions pertaining to the enterprise architecture; information pertaining to integration challenges of enterprise applications within the enterprise architecture; and any risks within the enterprise architecture. Based on the responses and the integration information, an operational performance of the enterprise architecture is determined and compared to best practice data. The best practice data corresponds to similar enterprise architectures that were determined to have performed at optimal levels. Based on the comparison, an assessment of the enterprise architecture is generated. Architectural alternatives are then recommended based on the assessment and the identified risks.

II. Computerized Implementation

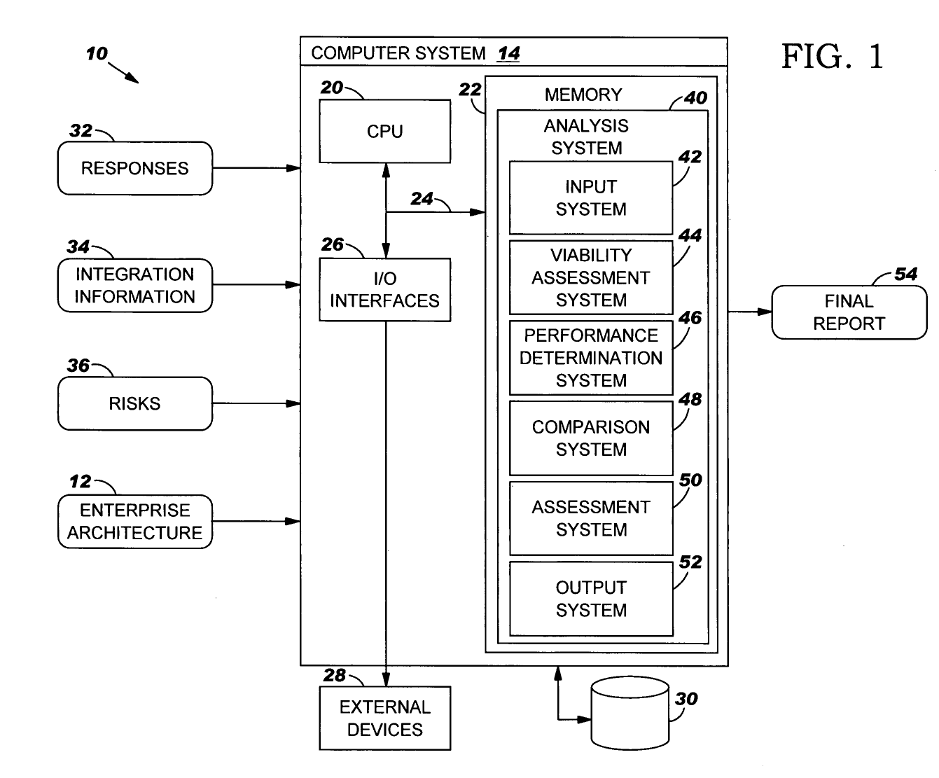

Referring now to FIG. 1, a system 10 for assessing enterprise architecture 12 is shown. Under the present invention, enterprise architecture 12 is assessed based on statistical, analytical and cognitive analyses. Specifically, as will be further described below, the assessment is made based on responses 32 to a plurality of questions pertaining to enterprise architecture 12, integration information 34 pertaining to a business environment in which enterprise architecture is implemented, and risks 36 within enterprise architecture 12.

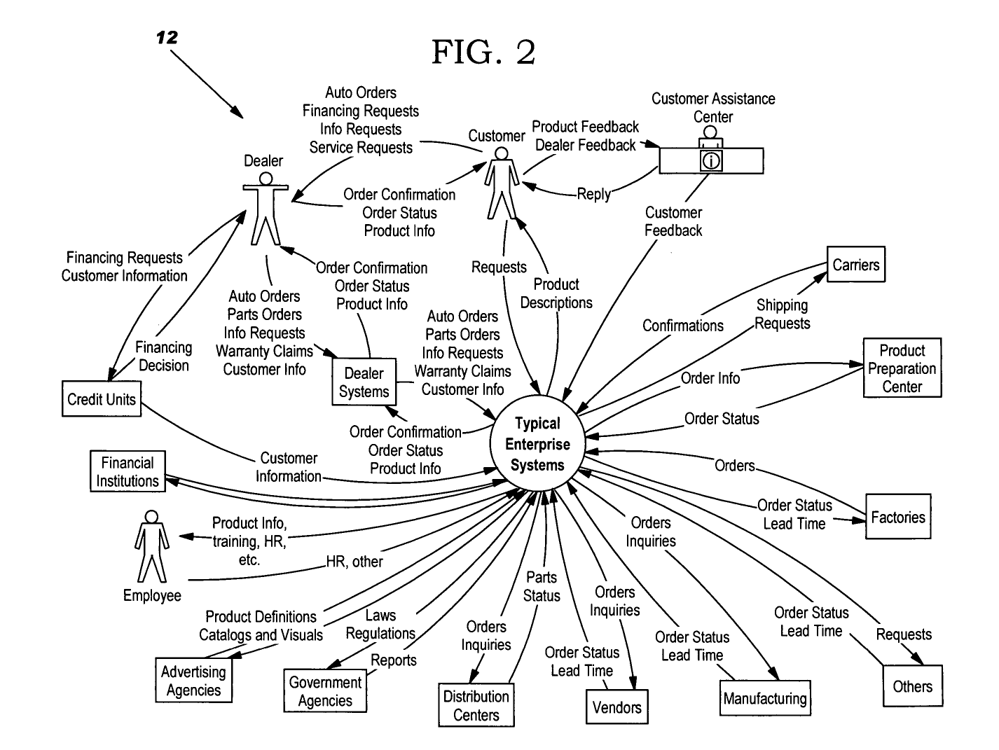

FIG. 2 depicts enterprise architecture 12 in greater detail. In this example, enterprise architecture 12 pertains to an automobile manufacturer. Enterprise architecture 12 can include any type of resources such as hardware, software, personnel or any combination thereof. Moreover, enterprise architecture 12 can include resources for communicating over a network such as the Internet. In any event, it should be appreciated that an enterprise architecture such as that shown in FIG. 2 can be depicted graphically in different views (e.g., in business, technology, and infrastructure architecture views). Collectively, those views and the supporting documentation should address the policy, organizational, technical, and business information relevant to the enterprise. Business context diagraming such as that shown in FIG. 2 is an element of business architecture diagraming. Specifically, it depicts the major users (internal or external to enterprise) that interact with the enterprise applications and data. The applications within the “enterprise systems” central node of the diagram may include many legacy systems that have been implemented in a stovepipe manner. No clean or well-defined interactions need exist between the “enterprise systems” and the users, or between the “enterprise systems” internally. Many such interactions may occur only with human interaction duplicating effort and data. The external interfaces may include “thin” and “fat” client solutions. The depiction shown in FIG. 2 also shows the main stakeholders within the enterprise business context and illustrates key relationships. The present invention will perform a complete assessment of enterprise architecture 12 and determine whether any architectural alternatives should be implemented. It should be understood that enterprise architecture 12 is intended to be illustrative only, and that the present invention could be implemented to assess any type of enterprise architecture 12.

Referring back to FIG. 1, it should also be understood that in a typical embodiment, the assessment of enterprise architecture 12 is performed by analysis system 40 shown in memory 22 of computer system 14. However, this need not be the case. Rather, the functions described herein could be performed manually by one or more individuals (i.e., assessors). Further, it should be understood that the teachings of the present invention could be implemented as a business method in which fees or subscriptions are paid for providing assessments of enterprise architectures 12.

In any event, as depicted, computer system 14 generally comprises central processing unit (CPU) 20, memory 22, bus 24, input/output (I/O) interfaces 26, external devices/resources 28 and storage unit 30. CPU 20 may comprise a single processing unit, or be distributed across one or more processing units in one or more locations, e.g., on a client and server. Memory 22 may comprise any known type of data storage and/or transmission media, including magnetic media, optical media, random access memory (RAM), read-only memory (ROM), a data cache, etc. Moreover, similar to CPU 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LCD screen, handheld device, keyboard, mouse, voice recognition system, speech output system, printer, monitor/display, facsimile, pager, etc. Bus 24 provides a communication link between each of the components in computer system 14 and likewise may comprise any known type of transmission link, including electrical, optical, wireless, etc.

Storage unit 30 can be any system (e.g., database) capable of providing storage for information under the present invention. Such information could include, for example, received responses 32, integration information 34, risks 36 within enterprise architecture 12, best practice data, etc. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

It should be understood that responses 32, integration information 34 and risks 36 could be communicated to computer system 14 over a network such as over the Internet, a local area network (LAN), a wide area network (WAN), a virtual private network (VPN), etc. As such, communication with computer system 14 could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Moreover, connectivity could be provided by conventional TCP/IP sockets-based protocol. In this instance, an Internet service provider could be used to establish connectivity to computer system 14.

A. Data Collection

As indicated above, to fully assess enterprise architecture 12, certain pieces of data should be provided. As shown in FIG. 1, such data includes responses to questions 32, integration information 34 and risks 36 within enterprise architecture 12. As will be further described below, this data is generally provided by operators/owners of enterprise architecture 12. To this extent, this data can be determined by the operators of enterprise architecture 12 in collaboration with one or more assessors who are responsible for administering the assessment process. For example, to obtain responses 32, the operators of enterprise architecture 12 would first be provided with a questionnaire that includes questions designed to determine the business and information technology (IT) needs that currently face enterprise architecture 12. The responses can be prepared jointly by the operators and the assessors. Similarly, integration information 34 and risks 36 can be determined pursuant to workshops, meetings and the like between the operators and the assessors.

1. Responses to Questionnaire

The general purpose of the questionnaire is to determine the business and information technology-based needs that currently face enterprise architecture 12. As such, several types of questions can be posed. For example, the questions can pertain to:
(1) The business context/environment in which the enterprise architecture 12 is implemented. Typical questions to determine this could include: “What business processes, business functions (components), information, roles and locations must be addressed?”
   “What are the business and IT goals for the enterprise architecture 12?” and “What are the key users, entities and systems interacting with enterprise architecture 12?”
(2) The system context of enterprise architecture 12. Typical questions to determine this could include: “What are the different types of client devices accessing the system?” and “What users/systems/entities are interacting with enterprise architecture 12 via which channels/devices?”
(3) IT environment, process and procedures of enterprise architecture 12. Typical questions to determine this could include: “What are the key IT roles and responsibilities?” and “How is the IT group organized?”
(4) General architecture of enterprise architecture 12. Typical questions to determine this could include: “Have the roles of business architect, application architect and technical architect been identified and assigned to individuals with sufficient experience?” and “Have the business architecture, application architecture and technical architecture been created?”
(5) User experience for those using enterprise architecture 12. Typical questions to determine this could include: “What are the primary user groups?” and “What are the primary user types?”
(6) Information architecture of enterprise architecture 12. Typical questions to determine this could include: “What information needs to be made available, to whom, and how?” and “What are the language requirements for business content?”
(7) Application architecture of enterprise architecture 12. Typical questions to determine this could include: “How do applications support the required functionality? “What are the primary applications within enterprise architecture 12?” and “What are the interactions among applications, users and external entities?”
(8) Content management of enterprise architecture 12. Typical questions to determine this could include: “What types of content, how is it maintained, published, and distributed?” Will the content for the web pages be stored in multiple places?” and “Will the content of the web pages be managed?”
(9) Data and integration architecture of enterprise architecture 12. Typical questions to determine this could include: “What is the enterprise data architecture—What are the data elements, where stored, and how are they accessed?” and “What is the current logical design of the databases?”
(10) Operational Architecture of enterprise architecture 12. Typical questions to determine this could include: “What infrastructure do we need to provide the required Service levels?” “What are the main components of the IT environment?” and “What environments are supported for different phases?”
(11) Security architecture of enterprise architecture 12. Typical questions to determine this could include: “What are the security and privacy requirements for the infrastructure and applications?” “What are the authentication/identification requirements for the various business processes?” and “Have the access requirements for the various data elements been identified?”
(12) Systems management of enterprise architecture 12. Typical questions to determine this could include: “Is there an ongoing performance planning process?” and “Is there an ongoing capacity planning process?”
(13) Functional and volumetric information of enterprise architecture 12. Typical questions to determine this could include: “Does a baseline of business volumetric information captured exist?” and “What are the current and future arrival rate of the various business sessions?”
(14) Testing of enterprise architecture 12. Typical questions to determine this could include: “Who will perform the testing?” and “What tools will they use?”
(15) Hosting of enterprise architecture 12. Typical questions to determine this could include: “Who is the provider?” and “Who owns the equipment?”

The questionnaire could also request information per application or system within enterprise architecture 12. For example, the operators could be requested to identify the access channels per user type, the total number of users, etc. In any event, it should be understood that the questions cited above are not intended as an exhaustive list of questions. Rather, they are cited herein only to illustrate the possible types of questions that can be posed. A more complete listing of illustrative questions is included in Appendix A, which is attached hereto and is herein incorporated by reference.

2. Integration Information

In addition to responses 32, to properly assess enterprise architecture 12, information pertaining to the integration challenges among major applications (e.g., customer systems, marketing systems, commerce applications, etc.) of enterprise architecture 12 should also be provided. This “integration information” 34 could be determined pursuant to workshops, meetings and the like between the operators of enterprise architecture 12 and the assessors. Once it is determined, it will be provided to computer system 14 similar to responses 32.

3. Risks within the Enterprise Architecture

The final piece of data that is collected under the present invention are risks 36 within enterprise architecture 12. This information could not only be used to determine whether the current resources (hardware, software and/or personnel) are adequately addressing those risks, but also whether the current resources are unnecessarily exposing enterprise architecture 12 to risk. The risks 36 can also be used to recommend architectural alternatives for enterprise architecture 12. Similar to integration information 34, risks 36 can be determined based on workshops, meetings and the like between the operators of enterprise architecture 12 and assessors. Once the risks are identified, they can be populated into a viability assessment. This can occur prior to or during the assessment process. In the case of the former, the operators and/or assessors can populate the viability assessment and then provide the same to computer system 14. Alternatively, as will be further described below, the risks 36 can be provided to computer system 14 and subsequently populated into the viability assessment by viability assessment system 44.

III. Assessment of the Enterprise Architecture

In a typical embodiment, responses 32, integration information 34 and risks 36 will be received by input system 42. Upon receipt, if risks 36 were not provided as populated within a viability assessment, viability assessment system 44 will do so. In such a case, viability assessment system 44 could access a template or the like (e.g., in storage unit 30). In any event, to commence the assessment of enterprise architecture 12, performance determination system 46 will first compute/determine an operational performance of enterprise architecture 12 based on responses 32 and integration information 34. In computing the operational performance, performance determination system 46 will “collate” responses 32 and integration information 34 into some form of useable data such as a set of scores. This can be accomplished in any number of ways. For example, performance determination system 46 could assign scores or points based on certain responses or integration challenges. This could lead to a composite score that represents the operational performance of enterprise architecture 12. It should be appreciated, however, that any methodology for determining the performance of enterprise architecture 12 based on responses 32 and integration information 34 could be implemented.

Once the operational performance is determined, comparison system 48 will compare it to best practice data (e.g., as stored in storage unit 30) corresponding to operational performances of similar enterprise architectures. Specifically, the best practice data can be determined based on previous enterprise architectures that are similar to enterprise architecture 12 and were determined to have optimal or ideal performance. In identifying similar enterprise architectures, any type of standard can be applied. For example, a similar enterprise architecture could be one that is implemented in a similar business environment and/or has similar resources as enterprise architecture 12. In any event, the best practice data of similar enterprise architectures can be used to rate the operational performance of enterprise architecture 12.

Based on the comparison, assessment system 50 will generate an assessment of enterprise architecture 12. For example, if enterprise architecture 12 is not performing up to the best practice data, assessment system 50 will indicate as much. Assessment system 50 will also attempt to identify the resources within enterprise architecture 12 that are responsible for any sub-optimal performance. Moreover, assessment system 50 will also recommend architectural alternatives for enterprise architecture 12 to improve the operational performance. Such alternatives could include changes/alterations to hardware, software and/or personnel/individuals within enterprise architecture 12. In any event, in determining the architectural alternatives, the present invention will consider risks 36 from the viability assessment. Specifically, to help ensure that risks 36 are not realized, or are at least minimized, assessment system 50 is configured to take risks 36 into consideration when recommending architectural alternatives. Once the assessment is complete and any architectural alternatives are determined, assessment system 50 can generate a final report 54 that is outputted by output system 52. Final report 54 will include the details of the assessment process as well as any recommended architectural alternatives.

It should be understood that the present invention can be realized in hardware, software, or a combination of hardware and software. Any kind of computer system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

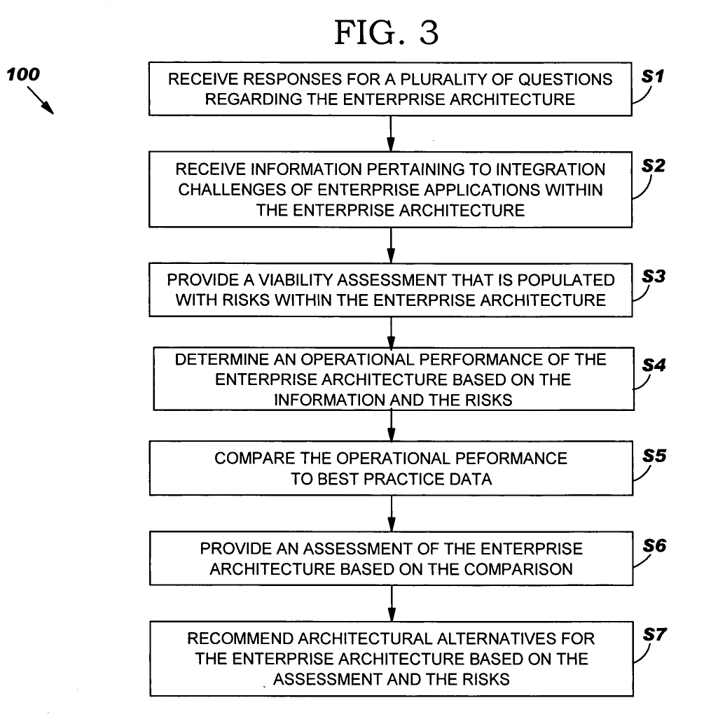

Referring now to FIG. 3, a method flow diagram 100 according to the present invention is shown. As depicted, first step S1 is to receive responses for a plurality of questions regarding the enterprise architecture. Second step S2 is to receive information pertaining to integration challenges of enterprise applications within the enterprise architecture. Third step S3 is to provide a viability assessment that is populated with risks within the enterprise architecture. Fourth step S4 is to determine an operational performance of the enterprise architecture based on the responses and the information. Fifth step S5 is to compare operational performance to best practice data. Sixth step S6 is to provide an assessment the enterprise architecture based upon the comparison. Seventh step S7 is to recommend architectural alternatives for the enterprise architecture based on the assessment and the risks.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for assessing an enterprise architecture, comprising:
receiving responses for a plurality of questions regarding the enterprise architecture;
receiving information pertaining to integration challenges of enterprise applications within the enterprise architecture;
providing a viability assessment that is populated with risks within the enterprise architecture;
determining an operational performance of the enterprise architecture based on the responses and the information;
comparing operational performance to best practice data; and
providing an assessment of the enterprise architecture based upon the comparing.

2. The method of claim 1, further comprising recommending architectural alternatives for the enterprise architecture based on the assessment and the risks.

3. The method of claim 2, wherein the architectural alternatives comprise at least one of altering hardware within the enterprise architecture, altering software within the enterprise architecture and altering personnel operating the enterprise architecture.

4. The method of claim 1, wherein the plurality of questions includes questions pertaining to at least one of business requirements, system context, information technology environment, general architecture, user experience, information architecture, application architecture, content management, data and integration architecture, operational architecture, security architecture, systems management, functional and volumetric information, testing and hosting of the enterprise architecture.

5. The method of claim 1, wherein the method is computer-implemented.

6. The method of claim 1, further comprising asking the plurality of questions in a questionnaire, prior to receiving the responses.

7. The method of claim 1, wherein the responses, the information and the risks are received from current operators of the enterprise architecture.

8. The method of claim 1, further comprising:
conducting meetings to determine the information pertaining to the business environment and to identify the risks within the enterprise architecture; and
populating the viability assessment based on the risks.

9. A computerized system for assessing an enterprise architecture, comprising:
an input system for receiving responses to a plurality of questions regarding the enterprise architecture, information pertaining to integration challenges of enterprise applications within the enterprise architecture, and risks within the enterprise architecture;
a performance determination system for determining an operational performance of the enterprise architecture based on the responses and the information;
a comparison system for comparing operational performance to best practice data; and
an assessment system for providing an assessment of the enterprise architecture based upon the comparison.

10. The system of claim 9, wherein the assessment system further recommends architectural alternatives for the enterprise architecture based on the assessment and the risks within the enterprise architecture.

11. The system of claim 10, further comprising an output system for outputting a report containing the assessment and the recommended architectural alternatives.

12. The system of claim 10, wherein the architectural alternatives comprise at least one of altering hardware within the enterprise architecture, altering software within the enterprise architecture and altering personnel operating the enterprise architecture.

13. The system of claim 9, wherein the plurality of questions includes questions pertaining to at least one of business requirements, system context, information technology environment, general architecture, user experience, information architecture, application architecture, content management, data and integration architecture, operational architecture, security architecture, systems management, functional and volumetric information, testing and hosting of the enterprise architecture.

14. The system of claim 9, wherein the risks are provided within a viability assessment received by the input system.

15. The system of claim 9, further comprising a viability assessment system for populating a viability assessment based on the risks received by the input system.

16. The system of claim 9, wherein the responses, the information and the risks are received from current operators of the enterprise architecture.

17. The system of claim 9, wherein the best practice data is based on operational performances of other enterprise architectures similar to the enterprise architecture.

18. A program product stored on a recordable medium for assessing an enterprise architecture, which when executed, comprises:
program code for receiving responses to a plurality of questions regarding the enterprise architecture, information pertaining to integration challenges of enterprise applications within the enterprise architecture, and risks within the enterprise architecture;
program code for determining an operational performance of the enterprise architecture based on the responses and the information;
program code for comparing operational performance to best practice data; and
program code for providing an assessment of the enterprise architecture based upon the comparison.

19. The program product of claim 18, wherein the program code for providing the assessment further recommends architectural alternatives for the enterprise architecture based on the assessment and the risks.

20. The program product of claim 19, further comprising program code for outputting a report containing the assessment and the recommended architectural alternatives.

21. The program product of claim 19, wherein the architectural alternatives comprise at least one of altering hardware within the enterprise architecture, altering software within the enterprise architecture and altering personnel operating the enterprise architecture.

22. The program product of claim 18, wherein the plurality of questions includes questions pertaining to at least one of business requirements, system context, information technology environment, general architecture, user experience, information architecture, application architecture, content management, data and integration architecture, operational architecture, security architecture, systems management, functional and volumetric information, testing and hosting of the enterprise architecture.

23. The program product of claim 18, wherein the risks are provided within a viability assessment received by the program code for receiving.

24. The program product of claim 18, further comprising program code for populating a viability assessment based on the risks received by the input system.

25. The program product of claim 18, wherein the responses, the information and the risks are received from current operators of the enterprise architecture.

26. The program product of claim 18, wherein the best practice data is based on operational performances of enterprise architectures similar to the enterprise architecture.
